(19) United States
(12) Patent Application Publication
(10) Pub. No.: US 2012/0023875 A1
(43) Pub. Date: Feb. 2, 2012

(54) PROTECTIVE MUZZLE SHIELD

(76) Inventor: Susan M. Gray, Monroe, GA (US)

(21) Appl. No.: 13/195,835

(22) Filed: Aug. 1, 2011

Related U.S. Application Data
(60) Provisional application No. 61/369,755, filed on Aug. 1, 2010.

(51) Int. Cl. B68C 5/00

(52) U.S. Cl. 54/80.1

(57) ABSTRACT

A muzzle shield for protecting the muzzle of an animal from the ultraviolet light of the sun. The muzzle shield includes a frustum-like structure in which the narrowest end is attached to the muzzle of the animal distal from the nose region and sides of the muzzle shield extend outward towards the nose, extending between approximately to the end of the nose to slight beyond the nose. The frustum-like shape characteristic of the muzzle shield advantageously restricts the amount of contact that the muzzle shield has with the muzzle of the animal to prevent irritation, overheating, entrapment of insects or debris, etc.

### CROSS-REFERENCE TO RELATED APPLICATIONS

This is a non-provisional application for patent being filed in the United States Patent Office under 35 USC 111 and 37 CFR 1.53(b) and claiming priority under 35 USC 119(e) to the provisional application for patent filed in the United States Patent Office on Aug. 2, 2010, bearing the title of PROTECTIVE MUZZLE SHIELD FOR HORSES and assigned Ser. No. 61/369,755, which application is incorporated herein by reference in its entirety.

### BACKGROUND

The present disclosure relates to the field of protective coverings for animals and, more specifically to a protective shield that can be worn over the nose of a horse, similar to a muzzle, but allows the horse to graze while providing protection to the horse against sunburns.

Similar to fair skinned humans, as well as any fair skinned animal, if some level of protection, shielding or filtering is not provided to light skinned areas of a horse, the sun can be quite harmful. Horses with light skinned muzzles can have damaging effects from exposure to the sun, including but not limited to blistering and/or severely burned skin, and even to the point of developing skin cancer. Due to the fact that there is limited or no hair on the muzzle or around the eyes, light or pink skinned areas are more susceptible to sunburn. Horses such as the Appaloosas, paints and other light-colored horses are especially vulnerable to the harmful rays of the sun. It should also be appreciated that while pink skinned horses are more susceptible to sunburn, dark skin horses can also incur a level of damage and, certain diseases can result in making a horse even more vulnerable to damage from the sun, such as liver disease, certain diets, etc. Further, there are many horses with light pink pigment all around the muzzle, nostrils, chin, lips and nose due to lack of hair in these areas.

Fortunately, the techniques used to provide protection against the sun for humans are also usable for horses. These techniques can include applying a lotion with an SPF rating of 30 or more, applying zinc oxide or providing shade from the sun. While applying sunscreen to the muzzle of a horse is a possible option, it is not an optimal solution. One of the problems with the option of applying sunscreen to the muzzle of a horse is that when the horse drinks, the sunscreen comes off in the drinking water. In addition, when the horse is grazing or eating on hay bales, the sunscreen comes off on the hay. Thus, using a sunscreen option to protect a horse's muzzle requires constant attention and maintenance by having to monitor the horse and reapply the sunscreen. In addition, sunscreen leaves a residue that attracts and holds dirt and debris. As such, the muzzle can get packed with dirt that can ultimately cause irritation. Thus, on top of being a high-maintenance option, there is also the potential that it may be harmful to ingest sunscreen on a regular basis. Furthermore, applying sunscreen can become a difficult task as after a horse is tender due to sun burning, they will fight to avoid having their muzzle touched. In addition, this can lead to other problems, such as the horse becoming head shy and or hard to catch, etc.

U.S. Pat. No. 7,204,071 issued to Walker and Amborn (2007) describe a protective face mask that protects only the upper portion of the horse's head and eyes from insects. Additionally, U.S. Pat. No. 7,624,558 issued to Pressler's (2009) describes a device that functions to prevent insects from infesting the eyes and face and they have combined the mask to function as a halter also. Neither of the devices presented in the '071 patent or the '558 patent present solution that effectively protects a horse's muzzle from sunburn.

Both U.S. Pat. No. 5,794,420 issued to Fine (1998) and United States Publication No. US 2008/0092497 filed in the name of Chang (2008) describe nose shields for horses. However, these coverings fail to protect the entire muzzle, which is very susceptible to harmful effects of the sun. The described devices only protect a portion of the upper nostrils or bridge of the nose and rest on the surface of horse's hair or skin. Further, the device described in the '420 patent is easily detachable which would result in lost articles and no protection.

U.S. Pat. No. 6,128,891 to McMahon (2000) describes an apparatus to help prevent insects from disturbing a horse. The apparatus described does not provide any protection from the sun. U.S. Pat. No. 7,690,332 to Merbeth (2010) is a muzzle for weaning foals humanely while it includes a snout cover it is not a solid material and is far too confining for an adult horse to wear while grazing and drinking. The ends of muzzle would protrude out to prevent horses from touching the ground comfortably where they tend to graze the freshest tender grasses.

### BRIEF SUMMARY

The present disclosure presents various embodiments, features, aspects and functions of an improved device for muzzle protection. In an exemplary embodiment of the muzzle shield, the muzzle shield can be constructed of a stiff moldable rigid material, or thick material such as burlap, or a screen material that has ultra violet ray protection, but other materials are also suitable. The material is pleated, folded, darted, biased or otherwise constructed to form a tent like dome, that advantageously keeps the surface of the shield away from the face or raised above the surface of the horse's hair or skin.

Thus, as presented in the background section, there is a need in the art for a device and method that can be used to protect the muzzle of a horse from the sun but that is a low maintenance solution in that the protection mechanism does not have to be tended to on a regular basis, does not create discomfort to the horse and does not restrict the horse from grazing or drinking. The various embodiments of the muzzle shield described herein can prevent the muzzle of a horse from being exposed to the damaging rays of the sun while outside but still allowing grazing or drinking easily. Many horses spend a considerable amount of time in the elements and, in fact many horses are in the elements twenty four hours a day. The disclosed muzzle shield allows horses to live in normal circumstances verses having to be kept up away from the sun.

In one embodiment of the muzzle shield, the shield wraps over the nose completely and around the mouth without clinging to horses face to avoid discomfort. In an exemplary embodiment, a thick binding can be used around the perimeter of the muzzle shield. The muzzle shield is smaller in the back under the chin to avoid dragging on the ground and potentially being stepped on by the horse, causing it to be pulled off of the horse. In exemplary embodiments, multiple straps made of nylon, leather or other durable material, can be attached to the binding on the top of muzzle shield (i.e., about 9 inches in length but could be longer or shorter), with some type of connector, such as hook and loop fasteners as a non-limiting example. A halter, modified fly mask or other headgear with a nose band can be used to install such an embodiment of a muzzle shield by wrapping the straps on the muzzle shield around the nose band section of headgear and looping the straps back onto themselves. In other embodiments, the head gear can be incorporated as a part of the shield itself. On the end of the muzzle shield, a strap with hook and loop fasteners can be attached while on the opposing end of the muzzle shield, a slit, hoop, loop, etc. can be included so that the strap can be slid thru and folded over to attach to itself. In another embodiment, straps can be included on both ends of the muzzle shield and connected together under the horse's chin or face. Other connection means are also anticipated, a few non-limiting examples include buckles, ties, buttons, snaps, zippers, laces, cinches, or the like.

The straps can be configured to allow complete adjustability for fitting to the horse. Typically, the muzzle shield completely circles the face, with the back underneath strap being the only covering for underneath the horse's chin. In exemplary embodiments, the muzzle shield does not cling, rub against, press against or has minimal contact with the horse's face so as to alleviate any irritation to the horse. In exemplary embodiments, the muzzle shield is constructed of a light weight material, is easily tolerable and easy to attach. Horses can graze easily without the muzzle shield touching their mouths and drink water comfortably. The muzzle shield can be made in multiple sizes to accommodate different breeds and sizes of horses, from miniature to the largest draft horse. Additionally, in an embodiment of the muzzle shield that uses straps to connect to another apparatus, a common fly mask could be altered to have slits, loops, hoops or rings around the nose band to accommodate attaching muzzle shield straps, the muzzle shield becoming an extension of the fly mask just as it is the extension of a halter or other head gear on a horse. In such an embodiment, an average horse size muzzle shield would have approximately five of the horizontal straps. As a non-limiting example, the straps can be 1 to 1½ inches in width with a strong hook and loop attachment for a secure fit, making it less likely to be removed by the horse rubbing or other horses.

These embodiments, as well as the above-listed features, aspects and functions will be more fully understood by reviewing the following figures, detailed description and claims.

### BRIEF DESCRIPTION OF THE SEVERAL VIEWS OF THE DRAWING

FIG. 1A and FIG. 1B illustrate perspective views of an exemplary muzzle shield in its operational environment with FIG. 1A being a front view of the exemplary muzzle shield being worn by a horse and FIG. 1B being a side view of the exemplary muzzle shield being worn by a horse.

FIG. 2 is a template drawing illustration one exemplary embodiment of the muzzle shield as well as a method for creating the shield portion of the muzzle shield.

showing the straight front view of the shield.

FIG. 3A is a side view elevation of the frustum-like shape of the face shield 110 when formed for installation on an animal.

FIG. 3B is a front view of the exemplary face shield illustrated in FIG. 3A.

FIG. 3C is a bottom side view of the exemplary face shield illustrated in FIG. 3A. FIG. 3 is a perspective right side view of the shield.

FIGS. 4A-4E are alternate embodiments of exemplary face shield template shapes.

FIG. 5 is a perspective view of the muzzle shield laying flat unattached.

FIG. 6 is a right side view of the muzzle shield attached to a halter.

FIGS. 7A-7C are sketches illustrating various other embodiments and/or configuration in which the muzzle shield could be utilized.

FIG. 8A and FIG. 8B are front and side elevations respectively of yet another embodiment of the muzzle shield.

### DETAILED DESCRIPTION OF EMBODIMENTS

The present disclosure presents embodiments, as well as aspects, functions and features of the various embodiments of a muzzle shield for protecting the muzzle of an animal from the ultraviolet light of the sun. An exemplary embodiment of the muzzle shield includes a frustum-like structure in which the narrowest end is attached to the muzzle of the animals distal from the nose region and sides of the muzzle shield extend outward towards the nose, extending between approximately to the end of the nose to slight beyond the nose. The frustum-like shape characteristic of the muzzle shield advantageously restricts the amount of contact that the muzzle shield has with the muzzle of the animal to prevent irritation, overheating, entrapment of insects or debris, etc. Various embodiments of the muzzle shield are described herein for illustrative purposes and it should be appreciated that variations in the presented embodiments are also anticipated.

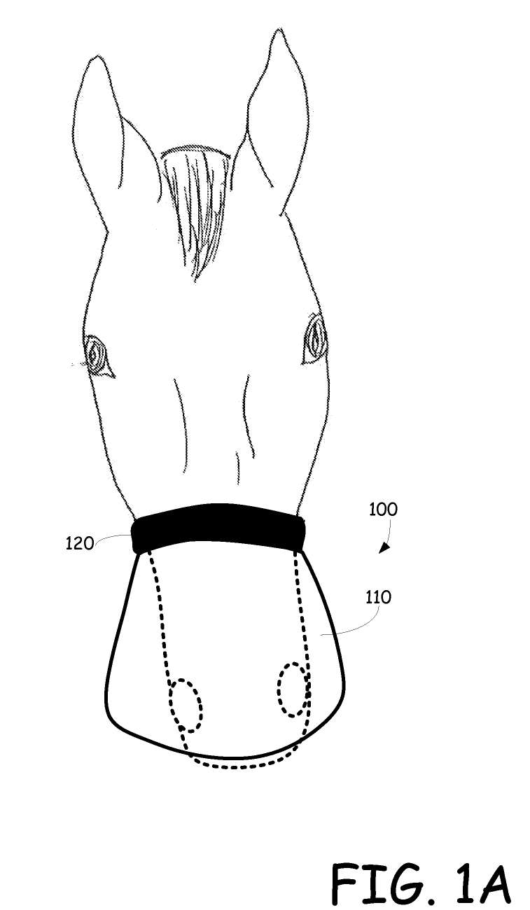

FIG. 1A and FIG. 1B illustrate perspective views of an exemplary muzzle shield in its operational environment with FIG. 1A being a front view of the exemplary muzzle shield being worn by a horse and FIG. 1B being a side view of the exemplary muzzle shield being worn by a horse. Referring to FIG. 1A, the exemplary muzzle shield 100 is illustrated as existing as an integrated-halter configuration including a face shield 110 and a halter 120. Referring to FIG. 1B, the illustrated embodiment of the muzzle shield 100 further illustrates that the halter 120, used for attachment to the horse or animal, includes a face strap 122 and a head strip 124. The head strap is secured to the face strap by means of a buckle 126. It should be appreciated that a buckle 126 may be used on either side of the halter 120 or both sides. In addition, a single buckle could be used at the back of the halter 120 behind the animal's ears. At the connection between the head strap 124 and the face strap 122 in which a buckle is not used, the head strap 124 can be sewn, braided, tied, snapped, buttoned or otherwise attached to the face strap 122. The buckle 126 allows the muzzle shield 110 to be adjusted to ensure that the muzzle shield covers the nose but does not extend so far beyond the nose to interfere with grazing or drinking.

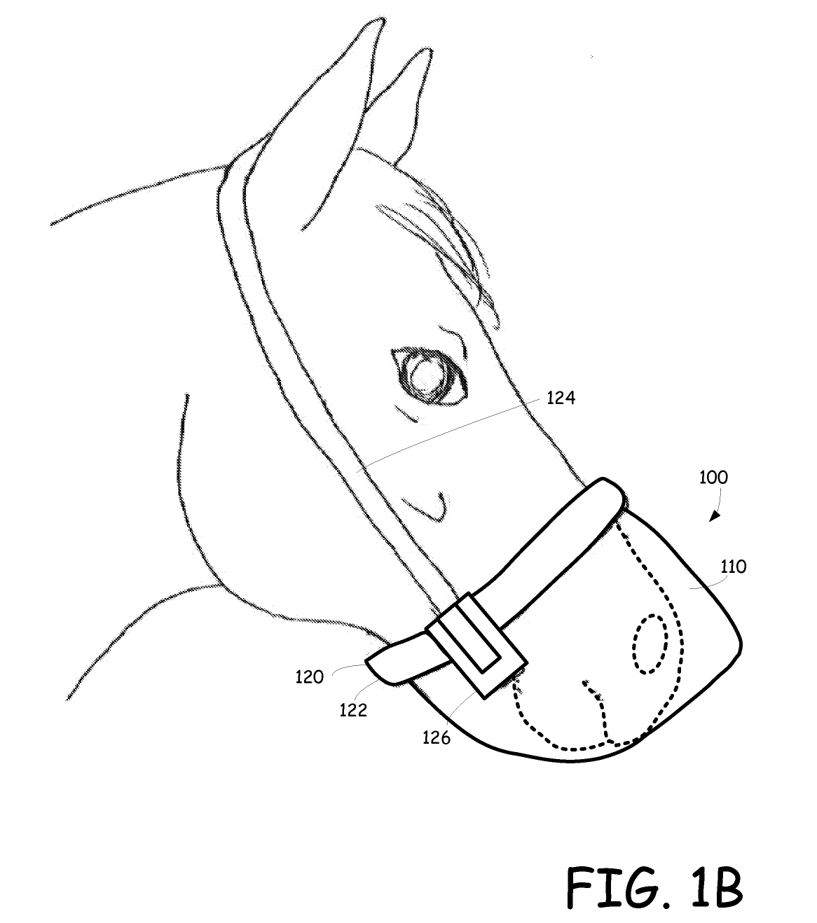

FIG. 2 is a template drawing illustration one exemplary embodiment of the muzzle shield as well as a method for creating the shield portion of the muzzle shield. Although specific dimensions are provided, it should be appreciated that the dimensions are only one example and other dimensions may be used. In addition, the ratios of the various measurements presented in FIG. 1 are also provided as an example and other ratios could be incorporated into various embodiments of the muzzle shield.

The illustrated muzzle shield is shown as being created out of elliptically shaped material which may be cut from a larger piece or bolt of material. In an exemplary embodiment, the material is a mesh material with sufficient stiffness to retain its shape but, sufficiently pliable to be bent and folded. In addition, in an exemplary embodiment, the material is a mesh cloth with ultraviolet filtering capabilities. A non-limiting example of a suitable material for various embodiments of the muzzle shield is Poly CB2 mx-90 available from Pro Tect Industries out of Fort Myers, Fla.

The illustrated elliptical shape has a diameter in one dimension (along the Y axis) of approximately 21 inches and a diameter in the orthogonal dimension (along the X axis) of approximately 17 inches. The face shield 110 is cut out from the elliptical shape in a crescent moon configuration with a nose edge 112 being convex and a base edge 114 being concave. The width of the exemplary face shield 110 across the center in the X dimension is approximately 8.5 inches. The nose edge 112 meets with the base edge 114 at distal points 116 and 118.

The base edge 114 arcs inwardly in a parabolic fashion from the distal points 116 and 118 at a radius such that the base edge apex 210 along a tangential line of symmetry of the parabolic base edge 114 is approximately 3.5 inches from a line that can be drawn between point 116 and point 118.

The nose edge 112 arcs inwardly in a parabolic fashion from the distal points 116 and 118 at a radius such that the nose edge apex 220 along a tangential line of symmetry of the parabolic nose edge 112 is approximately 12 inches from a line that can be drawn between point 116 and point 118 or 8.5 inches from the base edge apex 210.

The face shield shape illustrated in FIG. 2 advantageously allows for creating of a frustum-like shape of the face shield when the distal points 116 and 118 are brought in proximity to each other.

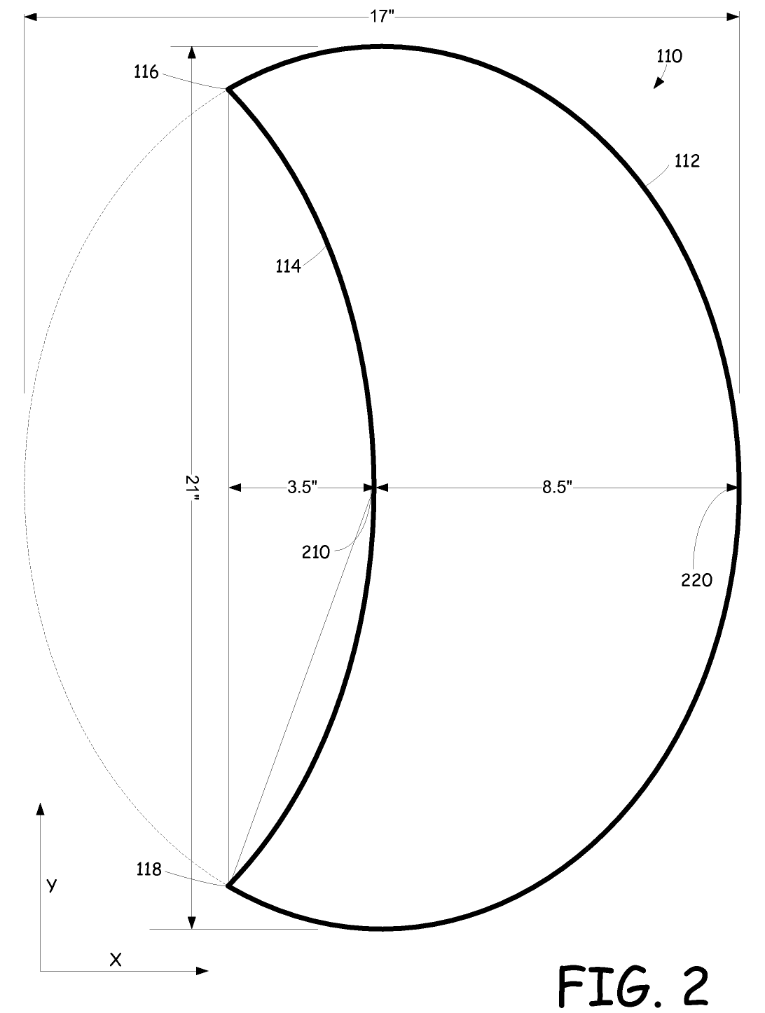

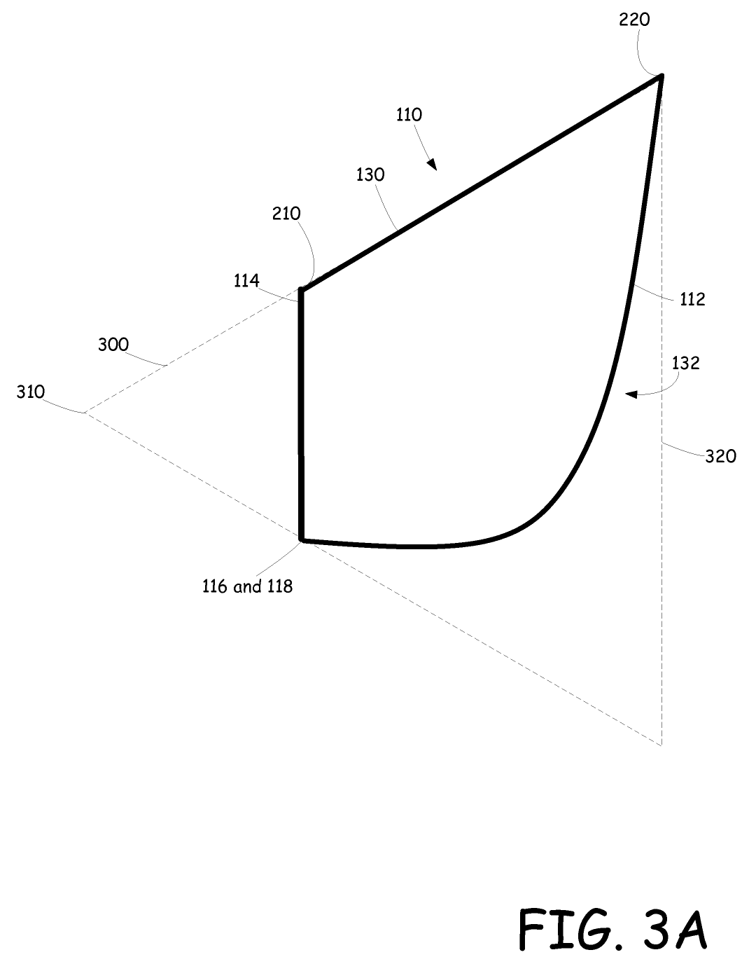

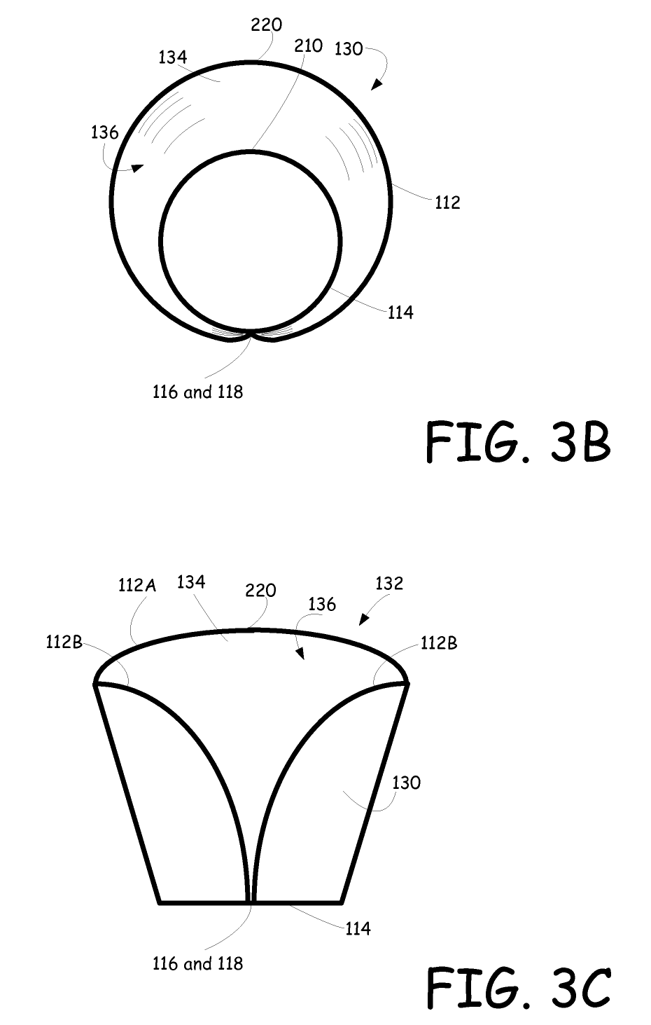

FIG. 3A is a side view elevation of the frustum-like shape of the face shield 110 when formed for installation on an animal. In mathematics, a frustum is a truncated cone in which the plane cutting off the apex is parallel to the base. In the illustrated example of FIG. 3A, a side view of cone 300 is shown in broken lines as including an apex 310 and a base 320. Points 116 and 118 are moved into proximity with each other in such a manner that the face shield 110 has a base edge 114 that is substantially in a single plane and is substantially parallel to the base 320 of the cone 300 and, the base edge 114 truncates the cone 300. However, rather than being true frustum shaped, the face shield 110 is configures such that the nose edge 112 tapers away from the cone base 320 curving towards the joined points 116 and 118. Advantageously, this configuration allows for the opening 132 to extend below the animals nose to further facilitate grazing and drinking. The top of the face shield 130 thus is shown as angling upward and outward from the base edge 114 towards the nose edge 112.

FIG. 3B is a front view of the exemplary face shield illustrated in FIG. 3A. In this view, the nose edge 112 is meeting or adjoining with the base edge 114 at points 116 and 118. The interior of the frustum-like structure 136 is shown as having a surface 134 that tappers outwards from the base edge 114 at the points 116 and 118 towards the nose edge 112 to a maximum distance at the nose edge apex 220 and base edge apex 210.

FIG. 3C is a bottom side view of the exemplary face shield illustrated in FIG. 3A. In this view, the opening of the frustum-like shape 132 is best illustrated. The nose edge 112 is shown as including a first segment 112A that in operation would extend above the animals nose. Segments 112B are shown as curving away from the nose starting near the side of the nose and curving towards the base edge 114 as the face shield wraps under the animal's chin.

To construct the embodiment illustrated in FIGS. 1A-1B, FIG. 2 and FIGS. 3A-3C, the template illustrated in FIG. 2, or a variant thereof, can be cut or stamped out of the desired material. As strap may be adjoined to the base edge 114 to provide additional stability and/or comfort. The face shield 110 can then be attached to the harness or halter 120 by any of a variety of fashions including, but not limited to, sewing, snaps, rivets, hook and loop, glue, buttons, zippers, belts, staples, as well as other techniques and/or combinations of one of more of these techniques.

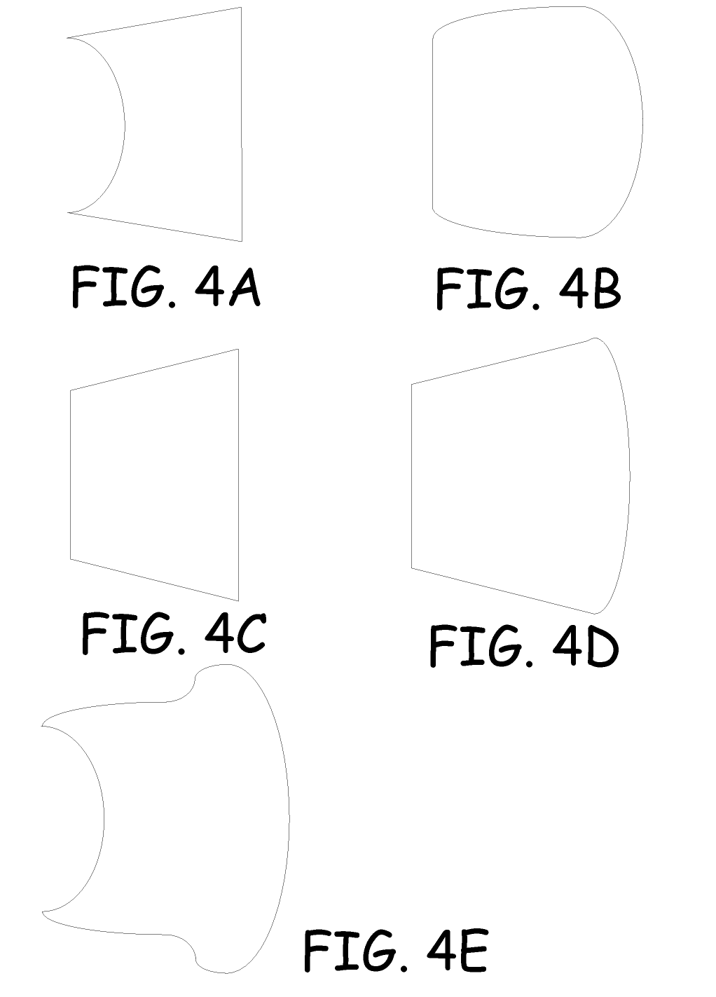

It should be appreciated that the face shield shape illustrated in detail in FIGS. 3A-3C are a non-limiting example of one embodiment and that other shapes are also anticipated. And, although the face shield shape illustrated in FIGS. 3A-3C advantageously is a simple design, and provides substantial coverage of the nose while not imposing undue restrictions on the ability to graze and drink water, other designs could also be utilize, including but not limited to, the shapes illustrated in FIGS. 4A, 4B, 4C, 4D and 4E. In addition, it will be appreciated that to enhance the tapering of the muzzle shield, pleats or darts may be integrated or sewn into the face shield 110 near the base edge and extending toward the nose edge.

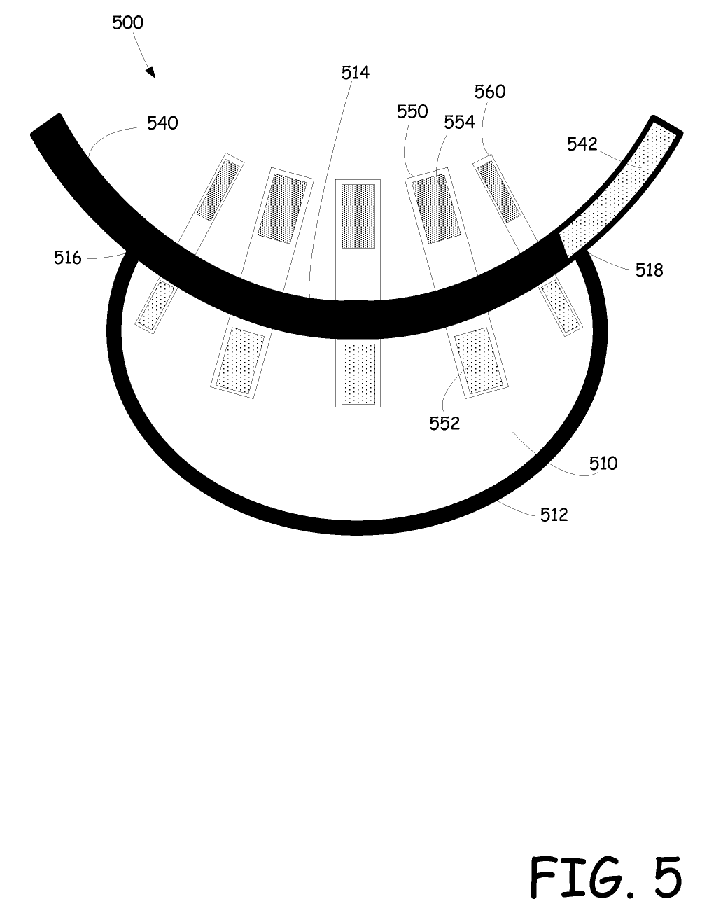

FIG. 5 is a plat diagram illustrating another exemplary embodiment of the muzzle shield suitable for attaching to a halter or other head gear. In the illustrated embodiment, the muzzle shield 500 includes a face shield 510 that has a nose edge 512 and a base edge 514. As with any of the variety of disclosed embodiments, the face shield 510 can be fabricated from a variety of materials including plastic, cloth, fiber glass, fiber cloth, burlap, woven material, leather, aluminum, rubber, silicone, or a variety of other materials or combinations of one or more of such materials, as well as materials similar in structure to Poly CB2 mx-90 available from Pro Tect Industries out of Fort Myers, Fla. The nose edge 512 of the face shield 510 is illustrated as having a piping or edging adhered thereto to provide additional support and prevent wearing out of the edges. The piping can be constructed of a variety of materials including plastic, leather, the same material as the face shield, nylon, etc. In addition, rather than piping the edge of the face shield 510 can be folded over as in a hem. A binding strap 540 is affixed or adjoined to the face shield 510 along the base edge 514 and extending out beyond the distal end points 516 and 518. The binding strap 540 can be any of a variety of materials including nylon, plastic, silicone, rubber, the same material as the face shield 510, as well as others. Further, in some embodiments the binding strap, as well as other portions of the muzzle shield may have sheep skin or other soft material to increase the comfort of the embodiment. The binding can be attached to the face shield in a variety of manners. A few non-limiting examples include sewing, gluing, snapping and riveting. In addition, the base strap 540 can be integral to the face shield 510 in that it can be cut out of the original material along with the face shield in a single unit.

On the side of the binding strap 540 that is visible in the drawing, on the end proximate to point 518, a fastening mechanism is attached 542. Not illustrated, but on the reverse side of the binding strap 540 on the end proximate to point 516, a mating fastening mechanism can be attached. For instance, if the fastening mechanism is loop and hook material such as VELCRO, mating materials could be affixed to opposing ends and opposing sides of the binder strap 540. However, it should be appreciated that other fastening mechanisms maybe utilized in various embodiments, including snaps, buttons, buckles, loops, ties, or the like. It may also be appreciated that the binding strap 540 may be permanently connected on the ends or consist as a single loop. In such embodiments, the muzzle shield could be slid over the nose of the animal.

A plurality of connection straps 550 are illustrated as being affixed, adjoined, adhered or other connected or integral to the face shield 510 and base strap 540. The illustrated embodiment has three connections straps 550 of one size and two connection straps 560 of a different size. In the illustrated embodiment, each of the connection straps 550 are shown as including hook and loop fastening mechanisms with material 552 being located on the connection strap 550 that is directly over the face shield 510 and mating material 554 being on the connection strap 550 that extends from the base edge 514 and base strap 540. Similarly, each of the connection straps 560 are shown as including hook and loop fastening mechanisms with material 562 being located on the connection strap 560 that is directly over the face shield 510 and mating material 564 being on the connection strap 560 that extends from the base edge 514 and base strap 540.

The embodiment of the muzzle shield illustrated in FIG. 5 is utilized by bringing point 516 and 518 proximate to each other, thereby forming a circle with base strap 540 and fastening the two ends of base strap 540 together behind or under the chin of the animal. The connection straps 550 and 560 can then be slid under a halter (not shown) or the halter placed over the connection strap 550 and 560, and the straps can be folded back over and onto themselves so that the fastening hook and loops 552 and/or 554 can be pressed together thereby securing the muzzle shield 500 to the halter and being installed on the animal.

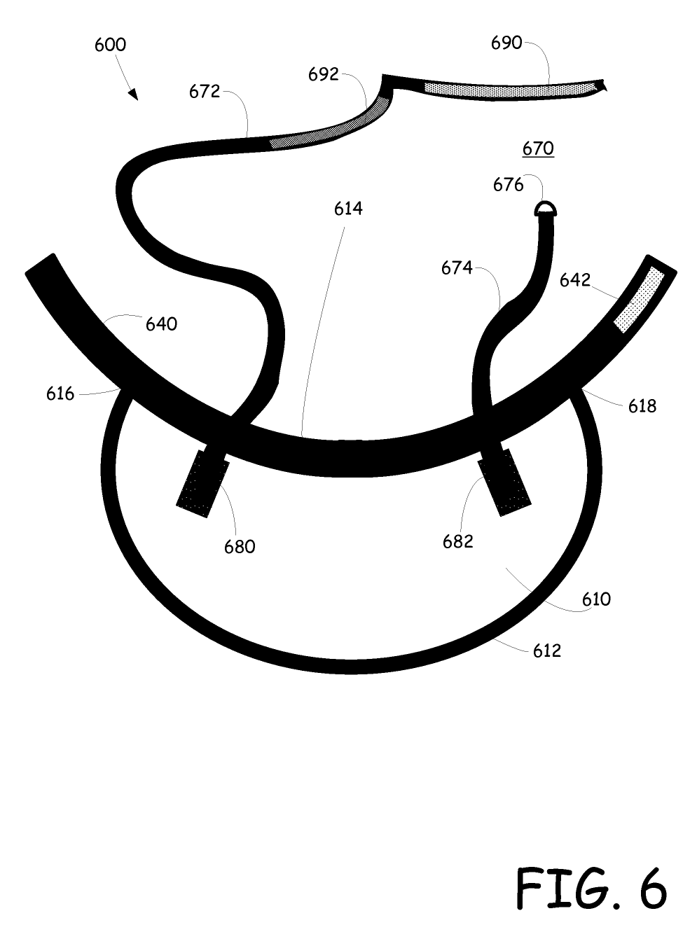

FIG. 6 is a plat diagram illustrating another exemplary embodiment of the muzzle shield integrated within a halter or head gear. In the illustrated embodiment, the muzzle shield 600 includes a face shield 610 that has a nose edge 612 and a base edge 614. The nose edge 612 of the face shield 610 is illustrated as having a piping or edging adhered thereto to provide additional support and prevent wearing out of the edges. A binding strap 640 is affixed or adjoined to the face shield 610 along the base edge 614 and extending out beyond the distal end points 616 and 618. On the illustrated side of the binding strap 640, on the end proximate to point 618, a fastening mechanism is attached 642. Not illustrated, but on the reverse side of the binding strap 640 on the end proximate to point 616, a mating fastening mechanism can be attached. For instance, if the fastening mechanism is loop and hook material such as VELCRO, mating materials could be affixed to opposing ends and opposing sides of the binder strap 640. However, it should be appreciated that other fastening mechanisms maybe utilized in various embodiments, including snaps, buttons, buckles, loops, ties, or the like. It may also be appreciated that the binding strap 640 may be permanently connected on the ends or consist as a single loop. In such embodiments, the muzzle shield could be slid over the nose of the animal.

The embodiment in FIG. 6 also includes a head strap 670 including an adjustable section 672 and a connection section 674. The adjustable section 672 of the head strap 670 is attached to the face shield 610. In the illustrated embodiment, a reinforcement material 680 is used in securing the adjustable section 672 to the face shield 610. The end of the adjustable section 672 opposite from the end connected to the face shield 610 is illustrated as including a hook and loop fastener with one piece of the hook and loop material 690 being located on the end of the head strap 670 distal from the face shield 610 and, the mating hook and loop material 692 being positioned on the same side of the head strap 670 but positioned closer to the face shield 610 end of the head strap 670 than the other hook and loop material 690.

The connection section 674 of the head strap 670 is illustrated as being attached to the face shield. In the illustrated embodiment, a reinforcement material 682 is used in securing the connection section 674 to the face shield 610. The opposing end of the connection section 674 includes a buckle 676. In the illustrated embodiment, the buckle 610 is a single D ring; however, it will be appreciated that two D rings, O rings, snaps, or other buckle types and fasteners may also be utilized.

The embodiment of the muzzle shield illustrated in FIG. 6 is utilized by bringing point 616 and 618 proximate to each other, thereby forming a circle with base strap 640 and fastening the two ends of base strap 640 together behind or under the chin of the animal. The head strap 67 can then be place over the animal's head behind the ears (not shown), and the straps the adjustable section 672 can be slid through the D ring buckle 676 and folded back over and onto itself so that the fastening hook and loops 692 and/or 690 can be pressed together thereby securing the muzzle shield 600 to the animal.

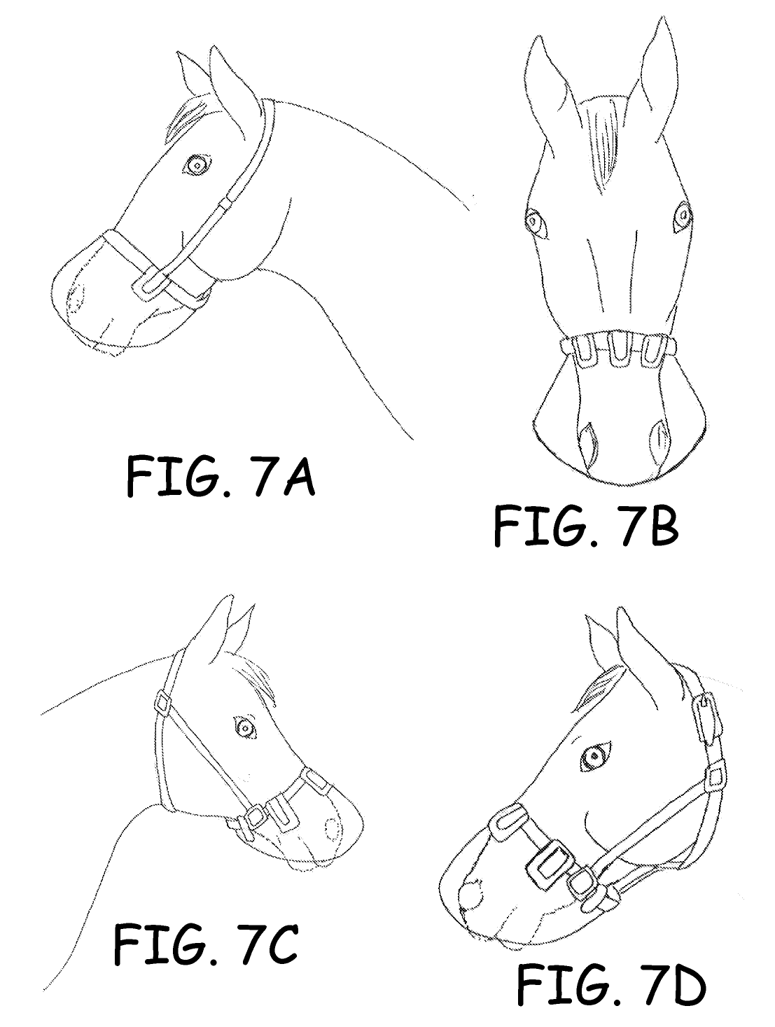

FIGS. 7A-7C are sketches illustrating various other embodiments and/or configuration in which the muzzle shield could be utilized.

It will be appreciated that the various embodiments of the muzzle shield may be attached to or integrated with full face protection devices, fly masks, and other gear. When the muzzle shield is worn, such as by attaching to a horse's head gear in one embodiment, the entire muzzle or nose area is covered from the harmful effects of the sun. The material is constructed, by shape and or pleats being sewn all the way around to form a frustum-like effect so as not to be resting directly on the horse's face or mouth. Advantageously, various embodiments presented herein of the muzzle shield allows the horse to move around in a natural manner. The muzzle shield does not impair the horse in from eating, grazing, drinking or even protecting himself by biting. The various embodiments can be easily attached to a horse's head gear such as a halter or modified fly mask or other embodiments. The material can be sturdy for long lasting usage. Advantageously, the horse can be out enjoying itself and not have the unpleasant problems that can be caused by over exposure to the sun. The muzzle shield however preferable is not attached in such a manner that in an emergency it would not come off. If the horse was caught in a fence or the like the attachment devices on the straps can be constructed such that they would release and free the animal.

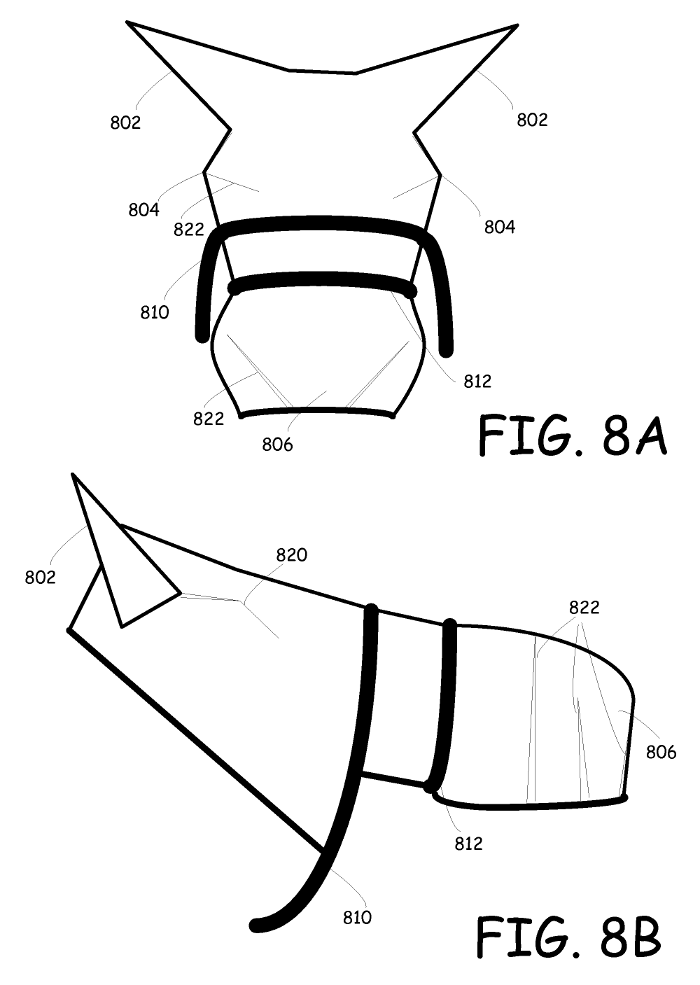

FIG. 8A and FIG. 8B are front and side elevations respectively of yet another embodiment of the muzzle shield. In this embodiment, a full facial shield is presented including ear pouches 802, eye pockets 804 and a full nose cover 806 that extends over the front of the nose. As in most of the described embodiments, the material can be constructed from a mesh material thereby allowing the animal to see out through the shield. A first strap 810 is used to secure the muzzle shield behind the jaw and a second strap 820 secures the muzzle strap under the chin. The muzzle shield includes various pleats or darts to give shape to the muzzle shield, such as pleats 820 to create eye pockets which allow the animal to open its eyes without getting rubbed by the muzzle shield. Also nose pleats 822 give a unique shape to the nose area such that the full nose area of the animal is protected or shielded.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

The various embodiments, as well as features, aspects and functions thereof, have been described using detailed descriptions of embodiments thereof that are provided by way of example and are not intended to limit the scope of the invention. The described embodiments comprise different features, not all of which are required in all embodiments of the automated contract mediator. Some embodiments of the muzzle guard use only some of the features or possible combinations of the features whereas some embodiments may utilize or employ all described features. Variations of embodiments of the present invention that are described and embodiments of the present invention comprising different combinations of features noted in the described embodiments will occur to persons of the art. Although certain features may have been described relative to particular embodiments, it is to be understood that any feature, aspect or characteristic presented for one embodiment may also be incorporated into other embodiments.

It will be appreciated by persons skilled in the art that the present invention is not limited by what has been particularly shown and described herein above. Rather the scope of the invention is defined by the claims that follow.

What is claimed is:

1. An apparatus that can be worn by an animal to shield the muzzle of the animal from the sun, the apparatus comprising:
a shield constructed of a sheet of material that provides a level of ultraviolet light filtering, the shield being shaped such that when it is laid flat, the shield includes a base edge and an extended edge, the base edge having a first length and being curved at a first radius from a first point to a second point, the extended edge having a second length that is greater than the first length and being curved at a second radius that is greater than the first radius from the first point to the second point;
a base strap that is adjoined to the based edge of the shield along the contour of the curve of the base edge, wherein when the base edge is held in curved position existing in a single plane by bringing the first point and the second point proximate to each other, the extended edge is forced to also curve but, the extended edge tapers outward at an angle from the base edge; and
a means for securing the shield around the muzzle of the animal.

2. The apparatus of claim 1, wherein the sheet of material is a mesh.

3. The apparatus of claim 1, wherein when secured to the muzzle of the animal, the base strap rests against the surface of the muzzle and the shield extends above the surface of the muzzle.

4. The apparatus of claim 1, wherein the means for securing the apparatus includes a plurality of hook and loop connection straps extending inward in a radial manner from the base edge.

5. The apparatus of claim 4, wherein the connection straps can be folded over a harness strap back onto themselves to secure the apparatus to the harness.

6. The apparatus of claim 4, further comprising a chin strap that includes a first section that extends from one end of the base edge and a second section that extends from the other end of the base edge, wherein the first and second sections can be joined together under the chin of the animal.

7. The apparatus of claim 1, wherein the securing means includes an first strap connected to a first surface of the muzzle shield and a second strap connected to a second surface of the muzzle shield, the first strap and the second strap including a fastener such that the first strap and second strap can extend behind the ears of the animal to secure the muzzle shield in place.

8. The apparatus of claim 6, further comprising a chin strap that includes a first section that extends from one end of the base edge and a second section that extends from the other end of the base edge, wherein the first and second sections can be joined together under the chin of the animal.

9. An apparatus that can be worn by an animal to shield the muzzle of the animal from the sun, the apparatus comprising:
a shield constructed of a flexible sheet of ultraviolet light filtering material, the shield being shaped such that when a first edge of the shield is held in a curved position such that it is substantially parallel with a plane, a second edge is also held in a substantially curved position such that the shield is in a substantially frustum shape with an open side; and
a means for securing the shield around the upper side of the muzzle of an animal such that the nose and a section extending towards the head of the muzzle is covered by the shield.

10. The apparatus of claim 9, wherein the sheet of material is a mesh.

11. The apparatus of claim 9, wherein when laid flat, the shield is substantially crescent shaped.

12. The apparatus of claim 9, wherein the first edge and the second edge are parabolic with the apex of the first edge is approximately 3.5 inches deep and the apex of the second edge is approximately 12 inches deep.

13. The apparatus of claim 1, wherein the first edge is curved and the second edge is curved and the first edge and the second edge meet at opposing to create a crescent shape having a first adjoining point and a second adjoining point, further comprising a base strap that is adjoined to the first edge of the shield along the contour of the curve of the first edge, wherein when the base edge is held in curved position existing in a single plane by bringing the first adjoining point and the second adjoining point proximate to each other, the extended edge is forced to also curve but, the extended edge tapers outward at an angle from the base edge; and
wherein when secured to the muzzle of the animal, the base strap rests against the surface of the muzzle and the shield extends above the surface of the muzzle.

14. The apparatus of claim 13, wherein the means for securing the apparatus includes a plurality of hook and loop connection straps extending inward in a radial manner from the first edge.

15. The apparatus of claim 14, wherein the connection straps can be folded over a harness strap back onto themselves to secure the apparatus to the harness.

16. The apparatus of claim 14, further comprising a chin strap that includes a first section that extends from one end of the first edge and a second section that extends from the other end of the first edge, wherein the first and second sections can be joined together under the chin of the animal.

17. The apparatus of claim 9, wherein the securing means includes an first strap connected to a first surface of the muzzle shield and a second strap connected to a second surface of the muzzle shield, the first strap and the second strap including a fastener such that the first strap and second strap can extend behind the ears of the animal to secure the muzzle shield in place.

18. The apparatus of claim 17, further comprising a chin strap that includes a first section that extends from one end of the base edge and a second section that extends from the other end of the base edge, wherein the first and second sections can be joined together under the chin of the animal.

19. A method for shielding the muzzle of an animal from the ultraviolet light of the sun, the method comprising the actions of:
creating a shield constructed of a flexible sheet of ultraviolet light filtering material, the shield being shaped such that when a first edge of the shield is held in a curved position along a first axis and the base edge exist entirely in the same plane along a second axis, a second edge is also held in a substantially curved position such that the shield is in a substantially frustum shape with an open side; and
securing the shield around the upper side of the muzzle of an animal such that the top and the sides of the nose and a section extending towards the head of the muzzle is covered by the shield.
